(19) United States
(12) Patent Application Publication
(10) Pub. No.: US 2002/0117014 A1
(43) Pub. Date: Aug. 29, 2002

(54) Four-dimensional gyroscope with self-action

(76) Inventor: Guennadi Chipov, Moscow (RU)

Correspondence Address: Lee, Mann, Smith,, McWilliams, Sweeney & Ohlson, P.O. Box 2786, Chicago, IL, 60690, US

(21) Appl. No.: 09/876,296

(22) Filed: Jun. 7, 2001

(30) Foreign Application Priority Data
Feb. 28, 2001 (TH) 063949

(51) Int. Cl. G01C 19/02

(52) U.S. Cl. 74/5.7

(57) ABSTRACT

I provide four-dimensional gyroscope with self-action demonstrating the movement of the center of the masses activated by the artificially created non-compensated inertial forces inside it, and which has a lower part and the upper part of the body with the photo-elements forming mass M together with the body of the device; and small masses synchronously rotating in the different directions and creating the rotational inertia; and during the rotation of the small masses, the body of the device, together with the small masses, move translationally along the axis x, creating the translational inertia; and the axis of the rotation of the small masses is fixed on the body, which is moving translationally establishing the connection between the translational and rotational inertia and the accelerating spring and motor-break provide the self-action of the device with the movement of the center of the masses.

### BACKGROUND OF THE INVENTION

1. Field of the Invention

Herewith is claimed the invention of the device, the center of the masses of which is moved by the non-compensated inertial forces. The device is based on the principle of the four-dimensional gyroscope, which demonstrates the violation of the momentum conservation law during the absolute elastic collision. This violation happens due to the connection between the translational and rotational inertia. The self-action four-dimensional gyroscope is based on the device creating the guided change of the rotational inertia that moves its center of masses.

2. Description of the Prior Art

All the contemporary Field theory from Newton's gravitation theory and up to Einstein's general relativity theory was developing as a theory of the translational relativity. In such theories the space is formed by the manifold of the translational coordinates, dealing with the translational motion of masses.

For the description of the translational motions of the free falling-lifts in the gravitational field A. Einstein has introduced the locally accelerated systems of the first kind, where the local gravitational force is compensated by the inertial force. That is why in Einstein's theory the inertial forces manifest themselves as real forces according to the 3rd law of Newton's mechanics. In the contemporary classic mechanics the inertial forces are not acting according to the 3rd law of Newton's mechanics, because it is not possible to indicate the body which they are applied to.

In order to resolve the mentioned above contradiction the author had developed the torsion theory of the inertial forces (“The Theory of Physical Vacuum” Moscow, ST-Center, 1998). According to the new theory the complete description of the inertial forces requires the extension of the general relativity theory by adding the rotational relativity. The rotational relativity has required the introduction of the 10-dimensional coordinates space, where there are 4 translational coordinates x,y,z,x^{o}=ct and 6 rotational coordinates φ₁, φ₂, φ₃, [symbol] , [symbol] , [symbol] . Besides that the angles φ₁, φ₂, φ₃ describe the “rotational” inertial forces connected with the changes of those coordinates, such as:

1) Centrifugal inertia force: F^{ρ}₁=−m[ω^{ρ}[ω^{ρ}r^{ρ}]],

2) Coriolis force F^{ρ}₂=−2m[ω^{ρ}v^{ρ}],

3) Inertial force, caused by the rotational irregularity F^{ρ}₃=−m[ω^{ρ}r^{ρ}], as well as the angles [symbol] , [symbol] , [symbol] denote the rotation of the matter in the space- time planes ct−x, ct−y and ct−z, which cause the appearance of the translational inertial force F^{ρ}₄=−mW^{ρ}. Unlike the Einstein's theory the new theory allows to investigate the free falling lifts rotating around a certain axis, where the inertial forces are acting locally, caused by rotation. Such forces are in action even though the gravitational field is absent and herewith we can discover the new class of the accelerated reference frames—the locally accelerated inertial reference frames of the second type. Such reference frames appear when the center of masses is effected by the inertial forces, which are compensating each other. The space of the events of the reference frames of the second kind has the structure of absolute parallelism, which has got both curvature and torsion. In general such space is not homogeneous and isotropic, that is why we observe the violation of the conservation laws which are effective in the ordinary Euclidean dimension.

The four dimensional gyroscope is a typical sample of the accelerated local inertial reference systems of the second type and there are three inertial forces affecting its center of masses

(M+2m)Ψ=(M+2m)Ψ−2mrΨ sin φ−2mrω² cos φ=0,

and compensating each other. In this equation Ψ-acceleration of the center of the masses of the gyroscope is equal to zero, that means that it moves with the uniformly or is at rest relatively to inertial reference frame. Nevertheless the reference frame, connected with its center of masses is accelerated because the inertial forces are acting though compensating each other. Thus we can state that in the above adduced equation the inertial forces satisfy the 3^{rd} law of Newton mechanics and perform as real forces, by guiding of which we can change the velocity of the center of masses without using the external forces. The four-dimensional gyroscope with self-action is the device, which demonstrates the transportation of its own center of masses after the effect of the artificially created internal forces in it.

### SUMMARY OF THE INVENTION

The invention of the four-dimensional gyroscope with self-action is claimed. The effect of self-action is achieved due to the utilization of the created and controlled inertial forces inside the device, which enables the motion of its center of the masses in spite of the absence of the action of the external forces.

In order to carry out the experimental research and to prove the correctness of this statement the four-dimensional gyroscope with self-action was constructed as well as the research center was established which allowed the following:

To prove experimentally the fact that the friction forces are not involved into the motion of the center of masses of the device.

To obtain the kinematical characteristics during the motion of the device as follows:

1) coordinate x(t) of masses M;

2) coordinate X_{c}(t) of the center of masses;

3) the angle of rotation φ(t)

With the help of the software to calculate:

1) velocity v(t) of massesM;

2) velocity v_{c}(t) of the center of masses;

3) angular velocity ω(t)

4) acceleration A(t) of masses M;

5) acceleration A_{c}(t) of the center of masses;

6) angular acceleration K(t) .

To demonstrate the movement of the device on the pendulum;

To demonstrate experiment Vijer, when the suspended device creates the draft and pools a cart.

### BRIEF DESCRIPTION OF THE DRAWINGS

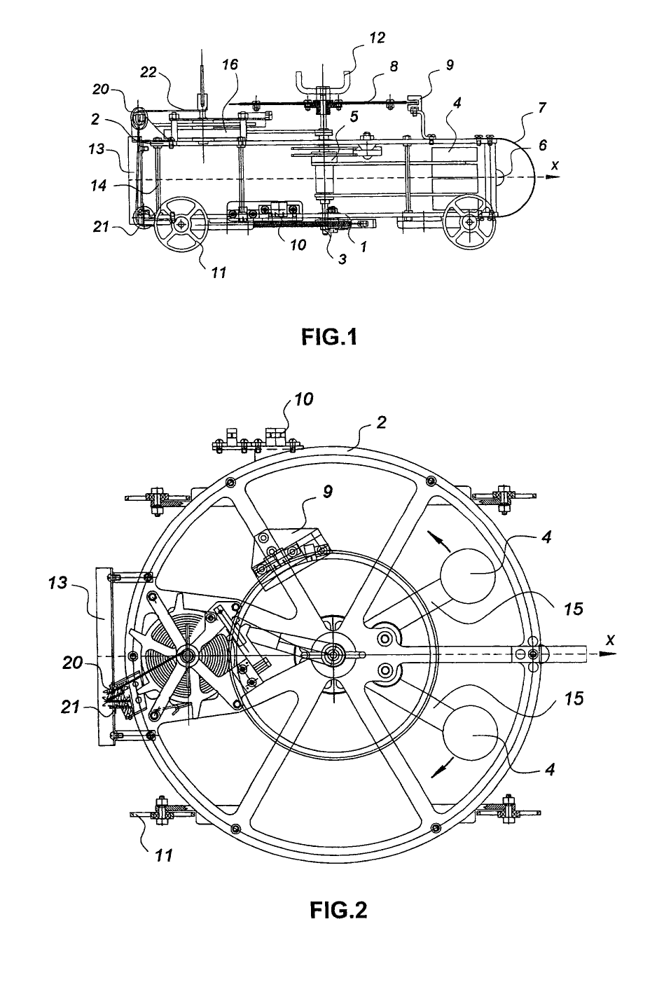

Ha FIG. 1 presents the view of the four-dimensional gyroscope, measuring blocks, motor-break, accelerating spring and supporting wheels.

Ha FIG.2 presents the top-view with small masses m positioned symmetrically along the longitudinal axis of symmetry x and accelerating spring

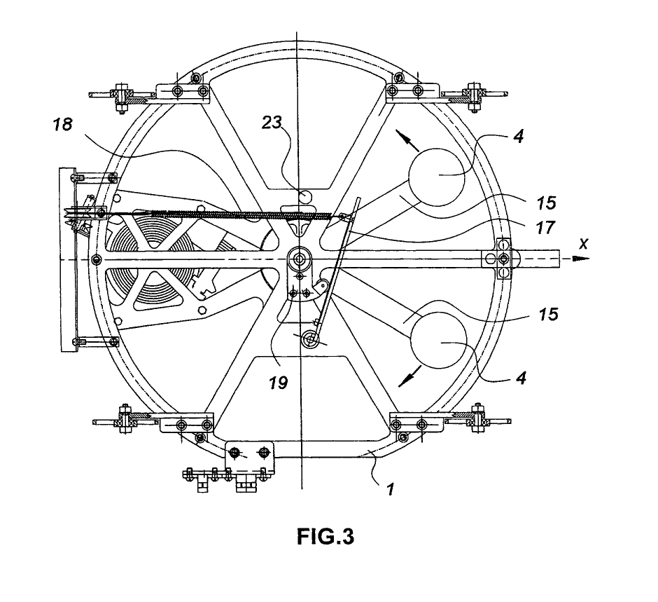

Ha FIG.3 presents the below view with the wheels, registering equipment and the elements of the motor-break.

### DESCRIPTIONS OF THE PREFERRED EMBODIMENTS

FIG. 1 represents the general view of the device—the four-dimensional gyroscope with self-action The lower part 1 and the upper part 2 of its body are made from aluminum and connected with the steel studs 14. The central shaft 3 is equipped with a differential 5, which rotates synchronously small masses 4 in the different directions. The technological handle 12 starts the rotation. When the small masses arrive at the angle 300°, the small spring 18 affects the cam 19 with the help of the lath 17, thus accelerating the rotation of the small masses 4. When the angle of the rotation arrives at 330° the accelerating spring 16 acts, increasing the angular velocity of rotation up to the angle of 360°. Beginning from the angle of 0° and up to the angle of 150° the small masses are in the free inertial rotation (self-action is absent). When the angular momentum will be 150° the cam 19 collides with the lath 17, that stretches the spring 18. As a result the angular momentum of the rotation of the small masses is decreasing.

The parameters of the angular of the rotation φ(t) during the motion of the four-dimensional gyroscope with self-action are being registered with the help of the polar ruler 8 and the photo-elements 9. The photo-elements 10 are synchronously registering the parameters of coordinates x(t) . The data are sent from the photo-elements to the computer for the further investigation. The specially developed software allows to monitor the basic kinematical parameters of the device during its motion in real time.

What is claimed is:

1. The four-dimensional gyroscope with self-action demonstrating the movement of the center of the masses activated by the artificially created non-compensated inertial forces inside it, consists of the following:
a. Lower part land the upper part 2 of the body with the photo-elements 3, 5, 6-22, forming mass M together with the body of the device;
b. Small masses 4 synchronously rotating in the different directions and creating the rotational inertia;
c. During the rotation of the small masses 4 the body of the device together with the small masses 4—mass M—moves translationally along the axis x, creating the translational inertia;
d. The axis of the rotation 3 of the small masses 4 is fixed on the body, which is moving translationally establishing the connection between the translational and rotational inertia;
e. The accelerating spring 16 and motor-break 17-19, providing the selfaction of the device with the movement of the center of the masses.

2. The device of claim 1 in which said that with the motion of the parts of the device the rotational inertia is transformed into the translational and vice versa.

3. The device of claim 2 in which said that with the absence of the external action both the rotational and translational vectors of the device are changed so that the center of the masses of the whole system moves with a certain velocity.

4. The device of claim 3 in which said that the self-action of the device is provided by the violation of the balance of the inertial forces inside it when the non-compensated inertial forces directed along the axis x appear and the center of the masses is changing its velocity.

5. The device of claim 4 in which said that as soon as the self-action along axis x finishes, the redistribution of the of the rotational and the translational inertia are taking place inside the device until they balance each other and then the center of the masses begins to move with the new constant velocity.

6. The device of claim 5 in which said that both the self-action and new velocity depend not only from the value of the internal impact but also from the angle of the disposition of the small masses towards the axis x, as well as from the starting value of the angular velocity of the rotation of the small masses

7. The device of claim 6 in which said:
a. It demonstrates the motion of the center of the masses affected by the inertial forces.
b. The external forces—the friction forces, aerodynamic forces, etc.—are the obstacles for the motion of the device and are not the source of the motion of the center of the masses;
c. The four-dimensional gyroscope with self-action may serve as a base for the creation of the engine of the principally new type aimed at the universal application.
